(19) United States
(12) Patent Application Publication
(10) Pub. No.: US 2004/0163502 A1
(43) Pub. Date: Aug. 26, 2004

(54) Socket wrench extension with improved torque transmission

(76) Inventor: Wan-Chun Li, Taichung (TW)

Correspondence Address: Kyle M. Globerman, Nelson Mullins Riley & Scarborough, LLP, P.O. Box 11070, Columbia, SC, 29211, US

(21) Appl. No.: 10/790,161

(22) Filed: Mar. 1, 2004

Related U.S. Application Data
(63) Continuation of application No. 10/086,487, filed on Feb. 28, 2002, now abandoned.
Application No. 10/086,487 is a continuation-in-part of application No. 09/638,699, filed on Aug. 14, 2000, now abandoned.
Application No. 09/638,699 is a continuation-in-part of application No. 09/100,987, filed on Jun. 22, 1998, now abandoned.

(51) Int. Cl. B25B 23/16

(52) U.S. Cl. 81/177.2

(57) ABSTRACT

A socket wrench extension includes a main body having a first end to be releasably engaged with a socket wrench and a second end. A driving column is formed on the second end of the main body so as to be releasably engaged with a socket. The driving column includes a recessed section defined in a periphery thereof adjacent to the second end of the main body, and a shoulder is defined between the recessed section and the second end of the main body. The socket may be engaged with the recessed section of the socket wrench extension to allow angular joint therebetween for operation in a difficult-to-operate condition. Alternatively, the socket may be engaged with the shoulder of the socket wrench extension to provide high torque transmission therebetween in which a longitudinal axis of the driving column coincides with that of the socket.

### CROSS REFERENCES TO RELATED APPLICATIONS

This is a continuation of U.S. patent application Ser. No. 10/086,487 filed on Feb. 28, 2002, which in turn is a continuation-in-part application of U.S. patent application Ser. No. 09/638,699 filed on Aug. 14, 2000, now abandoned, which, in turn, is a continuation-in-part application of U.S. patent application Ser. No. 09/100,987 filed on Jun. 22, 1998.

### BACKGROUND OF THE INVENTION

1. Field of the Invention

The present invention relates to a socket wrench extension with improved torque transmission.

2. Description of the Related Art

FIG. 5 of the drawings illustrates a typical extension 50 having a first end engaged with a socket-engaging member of a socket wrench 51 and a second end with a driving column 53 for engaging with a socket 52. A drawback of the extension 50 is that the driving column 53 cannot drive the socket 52 at an angle other than alignment, i.e., the axis of the driving column 53 must coincide with that of the socket 52. Yet, in some cases, it is difficult to operate the socket wrench in such alignment status.

FIG. 6 of the drawings illustrates an improved extension 60 having a first end engaged with a socket wrench 61 and a second end with a driving column 64 for engaging with a socket 62. A recessed section 65 is defined between the driving column 64 and a main body of the extension 60. As a result, the user may conveniently apply force to loosen/tighten a nut (not shown) or the like adjacent to a wall (not shown). However, the torque transmitted to the nut is lowered. Further, the stress will concentrate on the recessed section 65, which lowers the strength of the extension 60. As a result, the extension 60 cannot be used in cases where high torque is required.

U.S. Pat. No. 1,924,089 to Croessant issued on Jan. 9, 1932 discloses an extension member for socket wrenches wherein the extension can be disposed in an operating position at an angle to any of a plurality of interchangealbe sockets each having a suitably shaped cavity for engaging nuts or bolt heads of various sizes. Nevertheless, the extension member cannot be used in cases where high torque is required, either.

U.S. Pat. No. 4,436,005 to Hanson issued on Mar. 13, 1984 discloses a rotary torque adapter for transferring rotational torque force from a power source such as an electric drill to a socket tool device which transfers torque force to the nut or bolt being tightened or loosened depending upon the rotation direction. Such a rotary torque adapter is only suitable for transferring rotational torque force from a power source to a socket.

There is a long and unfulfilled need in a manual socket wrench extension that may be operated either in an upright manner when high torque is required or in an angular relationship with the socket for driving a nut or bolt head located in a place that is difficult to access.

### SUMMARY OF THE INVENTION

It is a primary object of the present invention to provide an improved socket wrench extension that allows angular joint between the socket and the driving column of the extension without adversely affecting the torque transmission.

The present invention provides a combination of a socket and an extension to solve the drawbacks of the prior art. The socket includes a first end having a square hole and a second end adapted to engage with a fastener. The square hole is defined by a plurality of sidewalls. Each sidewall has a concave portion in an intermediate portion thereof.

The extension comprises a main body having a first end adapted to be releasably engaged with a wrench and a second end spaced from the first end of the main body in an axial direction. A driving column is formed on the second end of the main body for releasable engagement with the square hole of the socket. The driving column includes a recessed section defined in a periphery thereof adjacent to the second end of the main body. The shoulder has a cross sectional size perpendicular to the axial direction that is greater than a cross sectional size of the recessed section perpendicular to the axial direction and smaller than a cross sectional size of the main body perpendicular to the axial direction, the driving column including a receptacle. A ball and an elastic element are received in the receptacle, the ball being biased by the elastic element to partially protrude out of the receptacle.

The main body, the shoulder, and the driving column including the recessed section are integrally formed as a single component.

The driving column is engageable with the concave portions of the square hole of the first end of the socket spaced from the main body with a gap being defined between the recessed section of the driving column and the sidewalls defining the square hole of the socket and with the ball pressing against one of the concave portions of the square hole under action of the elastic element. The concave portions of the square hole of the socket allows the driving column of the extension to move to a desired orientation relative to the socket, thereby allowing angular joint therebetween for operation in a difficult-to-operate condition.

The shoulder of the driving column being engageable with the sidewalls defining the square hole of the socket in a position other than the concave portions to provide high torque transmission therebetween in which a longitudinal axis of the driving column coincides with that of the socket, wherein the ball is received in the receptacle of the driving column and pressed against one of the sidewalls defining the square hole of the socket in a position other than the concave portions under action of the elastic element.

Other objects, advantages, and novel features of the invention will become more apparent from the following detailed description when taken in conjunction with the accompanying drawings.

### BRIEF DESCRIPTION OF THE DRAWINGS

FIG. 1 is a perspective view of a socket wrench extension in accordance with the present invention, a socket, and a socket wrench.

FIG. 2 is side view, partly sectioned, of the socket wrench, the extension, and the socket, illustrating engagement between the extension and the socket for a difficult-to-operation condition.

FIG. 3 is a view similar to FIG. 2, illustrating engagement between the extension and the socket for high torque transmission.

FIG. 4 is an enlarged view of a portion of FIG. 3

FIG. 5 is a side view of a conventional socket wrench extension, a socket wrench, and a socket in section.

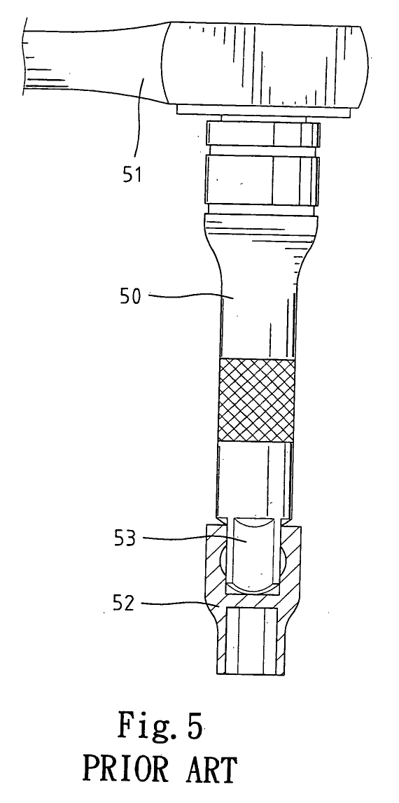

FIG. 6 is a side view of another conventional socket wrench extension, a socket wrench, and a socket in section.

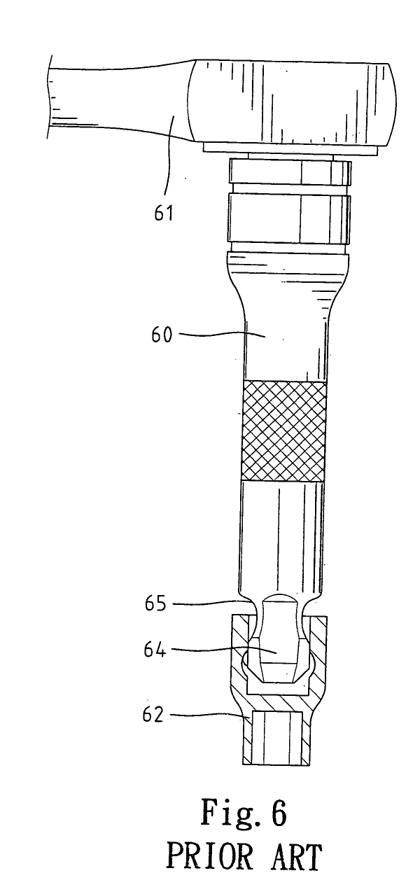

### DETAILED DESCRIPTION OF THE PREFERRED EMBODIMENT

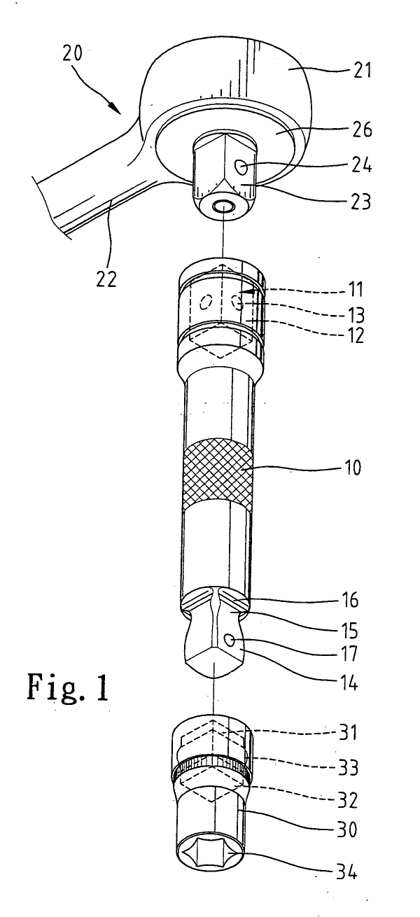

Referring to FIGS. 1 to 4 and initially to FIG. 1, a socket wrench extension in accordance with the present invention generally includes a main body 10 having a first end releasably engaged with a socket wrench 20 and a second end on which a driving column 14 is integrally formed so as to releasably engage with a socket 30, with the first and second ends being spaced in an axial direction.

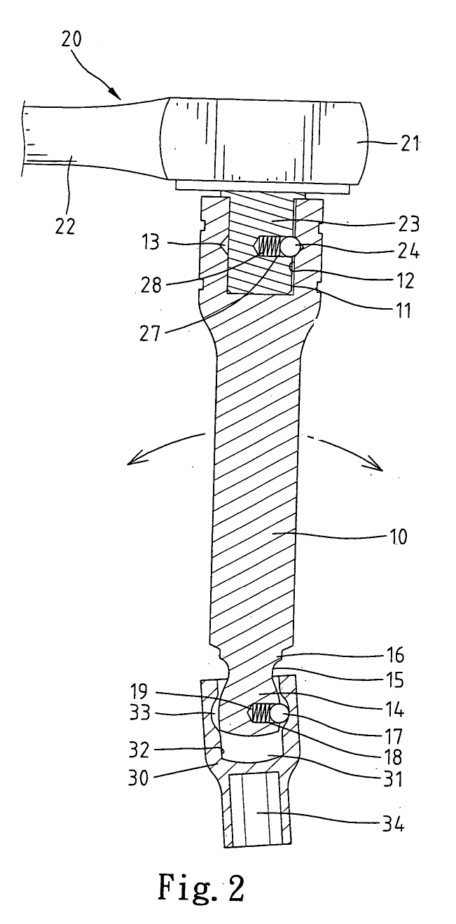

The socket wrench 20 includes a handle 22 and a head 21 extending from the handle 22. A drive member 26 is mounted in the head 21 and includes a drive end 23. The drive end 23 includes a receptacle 27 (FIG. 2) receiving an elastic element 28 and a ball 24. A portion of the ball 24 protrudes out of the receptacle 27 under the action of the elastic element 28.

The main body 10 of the extension includes a square hole 11 defined by plural inner wall faces 12 each having an engaging groove 13. The square hole 11 can be engaged with the drive end 23 of the socket wrench 20. The driving column 14 of the extension includes a recessed section 15 defined in a periphery thereof adjacent to the second end of the main body 10. In addition, a shoulder 16 is defined between the recessed section 15 and the second end of the main body 10. The shoulder 16 has a cross sectional size perpendicular to the axial direction that is greater than a cross sectional size of the recessed section 15 perpendicular to the axial direction and smaller than a cross sectional size of the main body 10 perpendicular to the axial direction. The drive column 14 further includes a receptacle 18 for receiving an elastic element 19 and a ball 17. A portion of the ball 17 protrudes out of the receptacle 18 under the action of the elastic element 19.

The socket 30 includes a first end having a square hole 31 and a second end having a hexagonal hole 34 for engaging with a fastener such as a nut or the like. The square hole 31 is defined by a plurality of sidewalls 32 each having a concave portion 33 in an intermediate portion thereof.

In use, referring to FIG. 2, the drive end 23 of the socket wrench 20 is engaged in the square hole 11 of the extension with the ball 24 of the drive end 23 being engaged in one of the engaging grooves 13. Thus, the wrench is securely engaged to the extension. Next, the driving column 14 of the extension is engaged in the square hole 31 in the first end of the socket 30 with the ball 17 of the driving column 14 pressing against one of the concave portions 33 of the socket 30 under the action of the elastic element 19. As illustrated in FIG. 2, there is a gap between the recessed section 15 of the driving column 14 of the extension and the sidewalls 32 defining the square hole 31. This allows angular joint between the recessed section 15 of the extension and the socket 30 for operation in a difficult-to-operate condition. Namely, the extension can be moved to a desired orientation while the socket 30 remains still. This is because the concave portions 33 of the square hole 31 allow rotational movement of the driving column 14 of the extension.

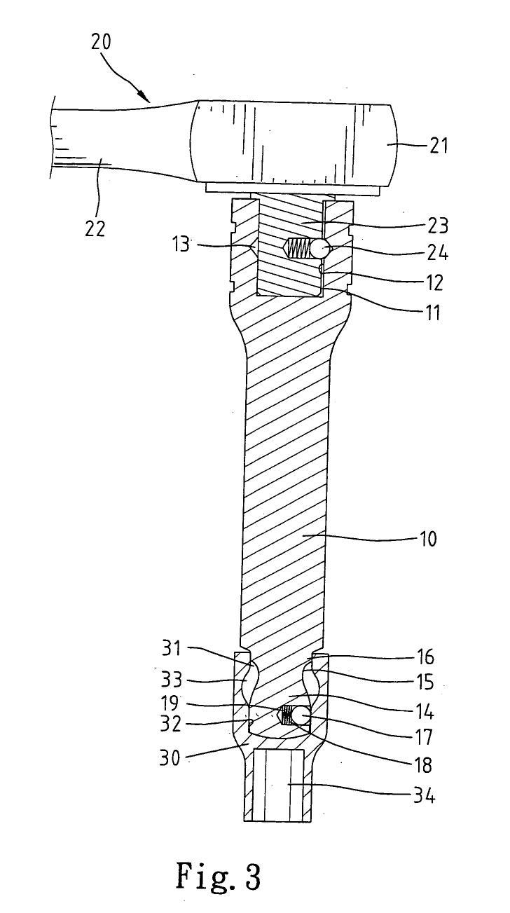

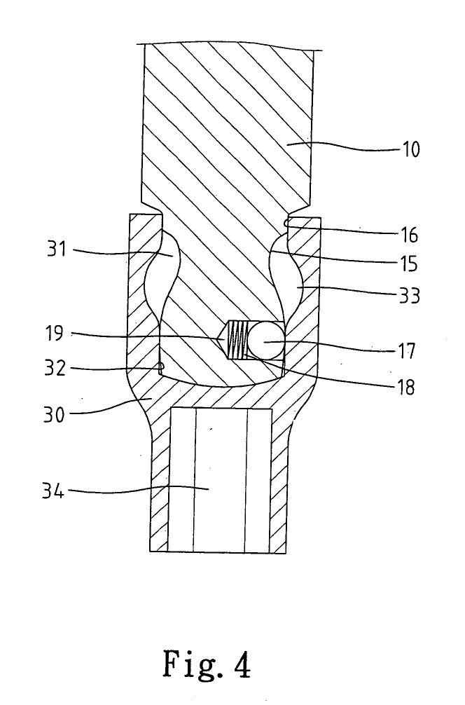

Alternatively, as shown in FIGS. 3 and 4, the driving column 14 of the extension may be engaged in the square hole 31 of the socket 30 with the shoulder 16 of the extension engaged with the sidewalls 32 defining the square hole 31 of the socket 30 in a position other than the concave portions 33 to allow high torque transmission in which a longitudinal axis of the driving column 14 coincides with that of the socket 30. It is noted that the ball 17 of the driving column 14 retracts into the receptacle 18 and the elastic element 19 is compressed. Nevertheless, the ball 17 still presses against one of the concave portions 33 of the socket 30 in a position other than the concave portion 33 under the action of the elastic element 19.

It is noted that the spindle of the extension disclosed in U.S. Pat. No. 1,924,089 to Croessant merely allows angular joint with the socket as shown in FIG. 1 thereof. Namely, the extension of Croessant's design cannot be used in an upright manner when high torque is required. The bead or flange adjacent to the neck of Croessant's design is intended to limit the engagement of head with socket opening as described in column 1, line 55 through column 2 lines 1-2 thereof, not for providing upright engagement with the socket.

Although the extension is described with reference to a socket wrench, it is noted that the extension may be used with other types of wrenches.

Although the invention has been explained in relation to its preferred embodiment, it is to be understood that many other possible modifications and variations can be made without departing from the spirit and scope of the invention as hereinafter claimed.

What is claimed:

1. A combination of a socket and an extension, the combination comprising:
a socket including a first end having a square hole and a second end adapted to engage with a fastener, the square hole being defined by a plurality of sidewalls, each said sidewall having a concave portion in an intermediate portion thereof; and
an extension comprising a main body having a first end adapted to be releasably engaged with a wrench and a second end spaced from the first end of the main body in an axial direction, a driving column being formed on the second end of the main body for releasable engagement with the square hole of the socket, the driving column including a recessed section defined in a periphery thereof adjacent to the second end of the main body, and a shoulder being defined between the recessed section and the second end of the main body, the shoulder having a cross sectional size perpendicular to the axial direction that is greater than a cross sectional size of the recessed section perpendicular to the axial direction and smaller than a cross sectional size of the main body perpendicular to the axial direction, the driving column including a receptacle, a ball and an elastic element being received in the receptacle, the ball being biased by the elastic element to partially protrude out of the receptacle;
the main body, the shoulder, and the driving column including the recessed section being integrally formed as a single component;
the driving column being engageable with the concave portions of the square hole of the first end of the socket spaced from the main body with a gap being defined between the recessed section of the driving column and the sidewalls defining the square hole of the socket and with the ball pressing against one of the concave portions of the square hole under action of the elastic element, the concave portions of the square hole of the socket allowing the driving column of the extension to move to a desired orientation relative to the socket, thereby allowing angular joint therebetween for operation in a difficult-to-operate condition; and
the shoulder of the driving column being engageable with the sidewalls defining the square hole of the socket in a position other than the concave portions to provide high torque transmission therebetween in which a longitudinal axis of the driving column coincides with that of the socket, wherein the ball is received in the receptacle of the driving column and presses against one of the sidewalls defining the square hole of the socket in a position other than the concave portions under action of the elastic element.

2. A socket wrench extension for engagement with a socket and a socket wrench comprising:
a. a main body having
a first end defining a cavity having a square cross-section and adapted to receive a portion of the socket wrench,
an opposite second end, and
an axis that extends through said first and said second ends;
b. a drive column proximate said main body second end, wherein said drive column is adapted to be received in a square cavity formed in one end of the socket and defining a longitudinal axis that is coincident with said main body axis;
c. a concave recess formed in said drive column; and
d. a shoulder formed intermediate said main body second end and said drive column annular recess, said shoulder having a cross section that is larger than a cross section of said drive column recess and smaller than a cross section of said main body, wherein each of said cross sections are taken perpendicular to said main body axis, and
wherein said drive column is receivable in the square cavity formed in the socket in
a first position in which said drive column axis intersects an axis of the socket at a non-zero angle, and
a second position in which said drive column axis is coincident with the axis of the socket and said shoulder is matingly received in the square cavity of the socket.

3. The socket wrench extension for engagement with a socket and a socket wrench of claim 2, further comprising:
a. a blind bore defined in said drive column, said blind bore having an axis that is perpendicular to said drive column axis;
b. a detent that is received in said blind bore, and
c. a spring that is received intermediate said blind bore and said detent.

4. The socket wrench extension for engagement with a socket and a socket wrench of claim 3, wherein said detent is a ball that is biased radially outward from said blind bore.

5. A socket wrench extension and a socket comprising:
a. a socket defining a cavity having a square cross-section therein and a second end adapted to engage a fastener; and
b. a socket wrench extension having
i. a main body that has
a first end defining a cavity having a square cross-section and adapted to receive a portion of a socket wrench,
an opposite second end, and
a longitudinal axis that extends through said first and said second ends;
ii. a drive column proximate said main body second end, wherein said drive column is adapted to be received in said socket first end square cavity, said drive column having a longitudinal axis that is coincident with said main body axis;
iii. a concave recess formed in said drive column; and
iv. a shoulder formed intermediate said main body second end and said drive column annular recess, said shoulder having a cross section that is larger than a cross section of said drive column recess and smaller than a cross section of said main body, wherein each of said cross sections are taken perpendicular to said main body axis, and
wherein said drive column is receivable in said socket first end cavity in
a first position in which said drive column axis intersects an axis of said socket at a non-zero angle, and
a second position in which said drive column axis is coincident with said socket axis and said shoulder is matingly received in said socket first end square cavity so that said socket first end abuts said main body second end.

6. A socket wrench extension and a socket comprising:
a. a socket having a first end defining a cavity having a square cross-section therein and a second end adapted to engage a fastener; and
b. a socket wrench extension having
i. a main body that has
a first end defining a cavity having a square cross-section and adapted to receive a portion of a socket wrench,
an opposite second end, and
a longitudinal axis that extends through said first and said second ends;
ii. a drive column proximate said main body second end, wherein said drive column is adapted to be received in said socket first end square cavity, said drive column having a longitudinal axis that is coincident with said main body axis;
iii. a concave recess formed in said drive column; and
iv. a shoulder formed intermediate said main body second end and said drive column annular recess, said shoulder having a cross section that is larger than a cross section of said drive column recess and smaller than a cross section of said main body, wherein each of said cross sections are taken perpendicular to said main body axis, and
wherein said main body is longer than said drive column, and
wherein said drive column is receivable in said socket first end square cavity in
a first position in which said drive column axis intersects an axis of said socket at a non-zero angle, and
a second position in which said drive column axis is coincident with said socket axis and said shoulder is matingly received in said socket first end square cavity so that said socket first end abuts said main body second end.

7. A socket wrench extension for engagement with a socket and a socket wrench comprising:
a. a main body having
a first end defining a cavity having a square cross-section and adapted to receive a portion of the socket wrench,
an opposite second end, and
an axis that extends through said first and said second ends;
b. a drive column proximate said main body second end, wherein said drive column is adapted to be received in a square cavity formed in one end of the socket and defining a longitudinal axis that is coincident with said main body axis; and
c. a concave recess formed in said drive column that bisects said drive column into a first part distal from said main body second end and a second part proximate said main body second end; and
wherein said drive column is receivable in the square cavity formed in the socket in
a first position in which said drive column first part is within said drive socket square cavity and said drive column second part is not so that said axis of said drive column intersects an axis of the socket at a non-zero angle, and
a second position in which both said first and said second drive column parts are received in said socket square cavity and said drive column axis is coincident with the axis of the socket.
